(19) United States
(12) Patent Application Publication
(10) Pub. No.: US 2002/0187771 A1
(43) Pub. Date: Dec. 12, 2002

(54) Charging information managing apparatus

(76) Inventors: Toshiharu Eto, Fukuoka (JP); Yuji Gotou, Fukuoka (JP); Katsuyuki Fujiyoshi, Fukuoka (JP); Osamu Sakaki, Fukuoka (JP); Kyoko Ichibangase, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/012,111

(22) Filed: Oct. 22, 2001

(30) Foreign Application Priority Data
May 25, 2001 (JP) 2001-157033

(51) Int. Cl. H04M 11/00

(52) U.S. Cl. 455/406; 455/407; 455/408

(57) ABSTRACT

An IP address recognizing unit determines whether or not an IP address of a mobile IP terminal whose charging information is to be processed is managed by a local station. If the IP address is not managed, a MobileIP-Server searching unit determines which station is the home station of the IP address. Then, a different station information transmission determining unit and a different station IP charging apparatus transmitting unit transmit the charging information to the apparatus that is a different station IP charging apparatus and the home station of the IP address. Additionally, a different station IP charging apparatus receiving unit receives the charging information of the IP address, and stores the charging information in a charging information database (for different station transmission) and manages the charging information.

### BACKGROUND OF THE INVENTION

1. Field of the Invention

The present invention relates to a charging information managing apparatus in a network, and more particularly, to an apparatus summing up charges in an IP private communications network.

2. Description of the Related Art

With the recent progress of information communications technology, a communications network is transforming itself from a time division multiplexing voice system network such as a voice telephone, a facsimile, etc., which has been extensively used as an information transmission/communication means, to a dynamic multiplexing network using a digital communications network due to the popularization of a personal computer, etc.

Additionally, in such a dynamic multiplexing network, a technique enabling a voice communication, such as VoIP (Voice over IP) in an asynchronous communication using data packets is being implemented, and communications such as a conventional voice telephone, a communication between facsimiles are to be implemented via a network such as an IP network.

Furthermore, personal computers have been reduced in size and weight, and have become easy to carry, and also Mobile IP techniques with which such portable terminals can be connected to a network regardless of the configuration (address) of a network to be connected are in development.

With such techniques, a personal computer can be connected to a carrier from within an IP private network by using a device such as a voice system PBX, a media server, etc. as a gateway with the use of a technique such as VoIP, etc.

Additionally, a person who possesses a personal computer can also make a call from a network at a moving destination to a carrier with the personal computer (hereinafter referred to as a mobile IP terminal) that is connected with Mobile IP, when moving from a home location to which the person originally belongs.

At this time, a charge made to a connected network or carrier must be managed at each home location to which the mobile IP terminal belongs.

However, with a current charging apparatus, a charge made when a mobile IP terminal moves to a different location and makes a call is collected not by a charging apparatus at the home location to which the mobile IP terminal belongs, but by the charging apparatus at the location where the mobile terminal makes a call.

FIG. 1 exemplifies the configuration of a conventional IP charging apparatus performing a charging process at a location where a mobile IP terminal makes a call.

A charging information obtaining unit 1 is intended to obtain a call record of a mobile IP terminal, which is stored in an exchange or a gatekeeper. A charge calculating unit 2 calculates a call charge based on the call record obtained by the charging information obtaining unit 1 upon receipt of a charge calculation request from the charging information obtaining unit 1. A charging information storing/managing unit 3 stores the charging information calculated by the charge calculating unit 2 in a charging information database, which is an external file, upon receipt of a charging information storage request from the charge calculating unit 2. A timer unit 4 is a timer used when a timeout monitoring process or a process at a predetermined time is performed within an IP charging apparatus. An outputting unit 5 is intended to output the charging information transmitted from the location where the mobile IP terminal makes a call to a user of the mobile IP terminal upon receipt of a charging information disclosure request (a request to present the charging information to the user of the mobile IP terminal) from the user of the mobile IP terminal. An operation condition setting unit 6 is intended to set operation data stored within the IP charging apparatus.

As described above, the charging information of the mobile IP terminal that makes a call is stored only within the IP charging apparatus at the location where the terminal makes a call.

With the conventional techniques, an operation for making a charge summed up at each location to a home location which a mobile IP terminal that makes a call belongs to, and a determination of to which location a charge is made cannot be learned unless details of charging information stored at each location are examined.

### SUMMARY OF THE INVENTION

An object of the present invention is to provide a charging information managing apparatus that can efficiently collect charging information of a mobile terminal at a home station, and can collectively manage the charging information.

A charging information managing apparatus according to the present invention, which manages charging information when a mobile terminal makes a call via a network including a plurality of stations and is arranged at each of the stations, comprises a searching unit searching for the home station of a mobile terminal to be charged for a call, and a charging information transmitting unit transmitting charging information of the mobile terminal to the home station.

According to the present invention, charging information such as a call charge, etc. is collected and collectively managed by the home station of a mobile terminal, even if the mobile terminal moves and makes a call. Accordingly, all pieces of charging information can be collected only from the home station when charges are collected. Conventionally, charging information must be collected from each station that a mobile terminal uses when moving.

That is, charging information can be efficiently managed even in a mobile communication, and troublesomeness such as collecting a charge, etc., can be dramatically reduced.

### BRIEF DESCRIPTION OF THE DRAWINGS

FIG. 1 exemplifies the configuration of a conventional IP charging apparatus that performs a charging process at a location where a call is made;

FIG. 2 shows the configuration of an IP charging apparatus, which is a charging information managing apparatus according to a preferred embodiment of the present invention;

FIG. 3 shows the system configuration of the preferred embodiment according to the present invention;

FIG. 4 shows the data structures used in the preferred embodiment;

FIG. 5 shows the sequence of a communication between a MobileIP-Server searching unit and an FA/HA (Foreign Agent/Home Agent) router in the preferred embodiment according to the present invention;

FIG. 6 shows the sequence of a communication (the case of a normal communication) between a different station IP charging apparatus information transmitting unit and a different station IP charging apparatus information receiving unit in the preferred embodiment according to the present invention;

FIG. 7 shows the sequence of a communication (the case where a charging transmission start response is abnormal) between the different station IP charging apparatus information transmitting unit and the different station IP charging apparatus information receiving unit in the preferred embodiment according to the present invention;

FIG. 8 shows the sequence of a communication (the case where the charging transmission start response is not returned) between the different station IP charging apparatus information transmitting unit and the different station IP charging apparatus information receiving unit in the preferred embodiment according to the present invention;

FIG. 9 shows the sequence of a communication (the case where the charging information transmission response is abnormal) between the different station IP charging apparatus information transmitting unit and the different station IP charging apparatus information receiving unit in the preferred embodiment according to the present invention;

FIG. 10 shows the sequence of a communication (the case where a charging transmission start response is not returned) between a different station IP charging apparatus information transmitting unit and a different station IP charging apparatus information receiving unit in the preferred embodiment according to the present invention;

FIG. 11 shows the sequence of a communication (the case where a termination notification response is abnormal) between the different station IP charging apparatus information transmitting unit and the different station IP charging apparatus information receiving unit in the preferred embodiment according to the present invention;

FIG. 12 shows the sequence of a communication (the case where the termination notification response is not returned) between the different station IP charging apparatus information transmitting unit and the different station IP charging apparatus information receiving unit in the preferred embodiment according to the present invention;

FIG. 13 shows the sequence of a communication (the case of a normal communication) between an outputting unit and a user of a mobile IP terminal in the preferred embodiment according to the present invention;

FIG. 14 shows the sequence of a communication (the case where an electronic message in response to an output request is abnormal) between the outputting unit and a user of a mobile IP terminal in the preferred embodiment according to the present invention;

FIG. 15 shows the sequence of a communication (the case where a charging information transmission start indication (a response to a disclosure request) is not returned) between the outputting unit and a user of a mobile IP terminal in the preferred embodiment according to the present invention;

FIG. 16 shows the sequence of a communication (the case where a response to a charging information transmission start request is abnormal) between the outputting unit and a user of a mobile IP terminal in the preferred embodiment according to the present invention;

FIG. 17 shows the sequence of a communication (the case where a response to a charging information transmission start request is not returned) between the outputting unit and a user of a mobile IP terminal in the preferred embodiment according to the present invention;

FIG. 18 shows the sequence of a communication (the case where a response to a charging information transmission is abnormal) between the outputting unit and a user of a mobile IP terminal in the preferred embodiment of the present invention;

FIG. 19 shows the sequence of a communication (the case where a response to a charging information transmission is not returned) between the outputting unit and a user of a mobile IP terminal in the preferred embodiment according to the present invention;

FIG. 20 shows the sequence of a communication (the case where a response to a charging information transmission termination notification is abnormal) between the outputting unit and a user of a mobile IP terminal in the preferred embodiment according to the present invention;

FIG. 21 shows the communication sequence (the case where a response to a charging information transmission termination notification is not returned) between the outputting unit and a user of a mobile IP terminal in the preferred embodiment according to the present invention;

FIG. 22 shows the flow of a charging information obtaining unit in the preferred embodiment according to the present invention;

FIG. 23 shows the flow of a charging calculating unit in the preferred embodiment according to the present invention;

FIG. 24 shows the flow of a charging information storing/managing unit in the preferred embodiment according to the present invention;

FIG. 25 shows the flow of a MobileIP-Server searching unit in the preferred embodiment according to the present invention;

FIG. 26 shows the flow of a different station information transmission determining unit in the preferred embodiment according to the present invention;

FIG. 27 shows the flow of the different station IP charging apparatus information transmitting unit in the preferred embodiment according to the present invention;

FIG. 28 shows the flow of the different station IP charging apparatus information receiving unit in the preferred embodiment according to the present invention;

FIG. 29 shows the flow of the outputting unit in the preferred embodiment according to the present invention;

FIG. 30 shows the flow of a MobileIP-Server searching unit in the preferred embodiment according to the present invention (No. 1);

FIG. 31 shows the flow of the MobileIP-Server searching unit in the preferred embodiment according to the present invention (No. 2); and

FIG. 32 shows the flow of an IP address recognizing unit in the preferred embodiment according to the present invention.

### DESCRIPTION OF THE PREFERRED EMBODIMENTS

A preferred embodiment according to the present invention assumes the case of an IP private network implementing a VoIP service using Mobile IP. However, the present invention is not limited to this one. The preferred embodiment according to the present invention provides an IP charging apparatus that receives a call record of an exchange in a calling station, and dedicatedly calculates a charge incurred when a mobile IP terminal moves to a different station and makes a call. The IP charging apparatus comprises: a MobileIP-Server searching unit having a home station inquiring unit which inquires of a local station FA/HA router, which is registered within an FA/HA router management table based on an IP address from an exchange, about which station is the home station of a mobile IP terminal; a different station information transmission determining unit having an IP charging apparatus determining unit which determines an IP charging apparatus distribution destination of charging information from the contents of a home station inquiry and an intra-network IP charging apparatus management table; a different station IP charging apparatus information transmitting unit having a charging information transmitting unit which distributively transmits charging information of a transmission target from within a local station charging information database to a determined IP charging apparatus distribution destination; and a different station IP charging apparatus information receiving unit having a charging information receiving/storing unit which receives charging information from a different IP charging apparatus, and stores the charging information in a charging information database for different station transmission.

With this configuration, all charges incurred by calls made within an IP network can be automatically distributed to a managing location, even if a terminal moves with a mobile function.

Additionally, the IP charging apparatus may further comprise: a MobileIP-Server searching unit having an automatic registering unit making a registration to a local station IP-ADDR management table, when an IP address within charging information is recognized to be an IP address within the local station based on a result of the inquiry to the local station FA/HA router; and an IP address recognizing unit having a local station IP address recognizing unit determining whether or not to make an inquiry to the local station FA/HA router.

With this configuration, recognition can be made without making an inquiry to the local station FA/HA router after the IP address within the local station is registered to the local station IP-ADDR management table.

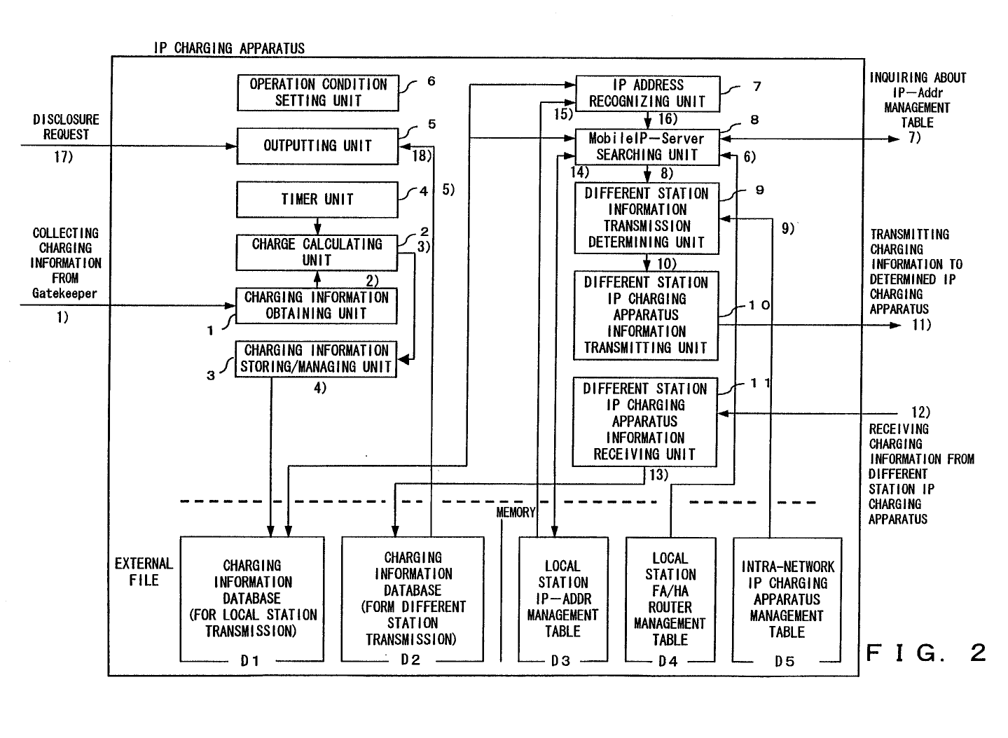

FIG. 2 shows the configuration of an IP charging apparatus, which is a charging information managing apparatus according to a preferred embodiment of the present invention.

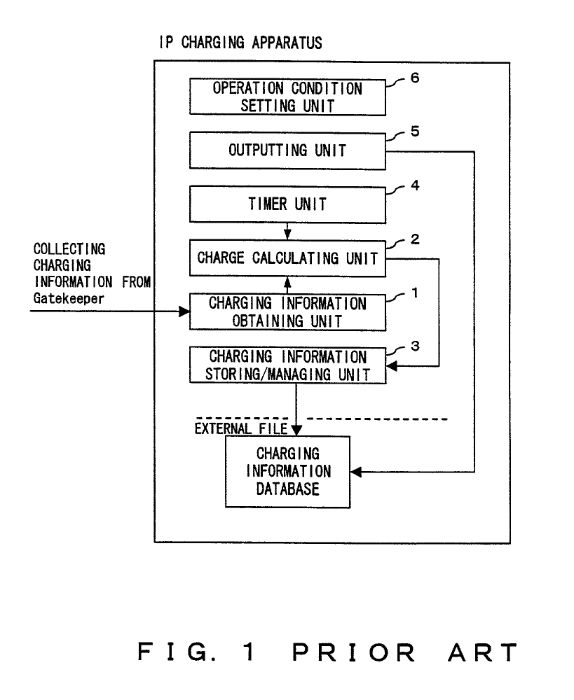

In this figure, the same constituent elements as those shown in FIG. 1 are denoted with the same reference numerals.

A charging information obtaining unit 1 is intended to obtain a call record of a mobile IP terminal, which is stored in an exchange. A charge calculating unit 2 is intended to calculate a call charge based on the call record obtained by the charging information obtaining unit 1 upon receipt of a charge calculation request from the charging information obtaining unit 1. A charging information storing/managing unit 3 is intended to store the charging information calculated by the charge calculating unit 2 in a charging information database (for local station transmission) Dl (corresponding to the charging information database shown in FIG. 1), which is an external file, upon receipt of a charging information storage request from the charge calculating unit 2.

A timer unit 4 is used when a timeout management process or a process at a predetermined time is performed within the IP charging apparatus. An outputting unit 5 is intended to output charging information to a user of a mobile IP terminal upon receipt of a charging information disclosure request from the user of the mobile IP terminal. An operation condition setting unit 6 is intended to set existing operation data stored within the IP charging apparatus, and to set data of a local station IP-ADDR management table D3, a local station FA/HA router management table D4, an intra-network IP charging apparatus management table D5, and the like.

An IP address recognizing unit 7 is intended to make a comparison between an IP address within the local station IP-ADDR management table D3, which is automatically registered by the MobileIP-Server searching unit 8, and an IP address within the charging information stored in the charging information database (for local station transmission), and issues a search request as a distributive transmission target of the charging information to the MobileIP-Server searching unit 8 only for an unregistered IP address.

The MobileIP-Server searching unit 8 is intended to inquire of a location station FA/HA router, which is registered to a local station FA/HA router management table D4, about a home station to which a mobile IP terminal that makes a call belongs based on an IP address within the charging information stored in the charging information database (for local station transmission) Dl. Additionally, the MobileIP-Server searching unit 8 automatically registers the IP address to the local station IP-ADDR management table D3 when the IP address within the charging information stored in the charging information database (for local station transmission) is recognized to be the IP address within the local station based on the contents of the inquiry to the local station FA/HA router.

A different station information transmission determining unit 9 determines an IP charging apparatus distribution destination of charging information from an intra-network IP charging apparatus management table D5 based on the contents of a home station inquiry made by the MobileIP-Server searching unit 8.

A different station IP charging apparatus information transmitting unit 10 is intended to distributively transmit charging information of a transmission target (a target mobile IP terminal of charging information to be processed) from within the local station charging information database D1 to the IP charging apparatus determined by the different station information transmission determining unit 9. A different station IP charging apparatus information receiving unit 11 is intended to receive charging information from an IP charging apparatus of a different station, and to store the charging information in a charging information database (for different station transmission) D2.

In the preferred embodiment according to the present invention, as shown in FIG. 2, the MobileIP-Server searching unit 8 inquires of an FA/HA router, which is registered to a local station FA/HA router management table D4, about the home station to which a mobile IP terminal that makes a call belongs based on the IP address within the charging information stored in the charging information database (for local station transmission). Additionally, the different station information transmission determining unit 9 determines an IP charging apparatus distribution destination of the charging information from an intra-network IP charging apparatus management table D5 based on the contents of the home station inquiry made by the MobileIP-Server searching unit 8.

The different IP charging apparatus information transmitting unit 10 distributively transmits the charging information of a transmission target from within the charging information database (for local station transmission) to the IP charging apparatus determined by the different station information transmission determining unit 9, and also transmits the charging information, whose calling station IP address is a different station as a home station among the charging information transmitted from the local station, to the IP charging apparatus of the home station.

Furthermore, the different station IP charging apparatus information receiving unit 11 receives charging information from a different station IP charging apparatus, and stores the charging information in the charging information database (for different station transmission) D2. When a mobile IP terminal whose home station is a local station moves to a different station, information of a charge incurred by a call made by the mobile IP terminal is stored in the charging information database (for different station transmission) D2 within the home station IP charging apparatus.

Accordingly, all charges incurred by calls within an IP network can be automatically distributed to a managing station, even if a terminal moves with a mobile function.

Additionally, when the MobileIP-Server searching unit 8 recognizes an IP address stored within the charging information database (for local station transmission) D1 to be an IP address within the local station based on the contents of the inquiry made to the local station FA/HA router, the IP address is automatically registered to the local station IP-ADDR management table D3. An IP address recognizing unit 7 makes a comparison between the IP address within the local station IP-ADDR management table D3, which is automatically registered by the MobileIP-Server searching unit 8, and the IP address within the charging information stored in the charging information database (for local station transmission) D1, and issues a search request as a distribution target of charging information to the MobileIP-Server searching unit 8 only for an unregistered IP address.

Accordingly, recognition such that a home station of a mobile IP terminal is a location station can be made without making an inquiry to the local station FA/HA router, once the IP address registration is made to the local station IP-ADDR management table D3.

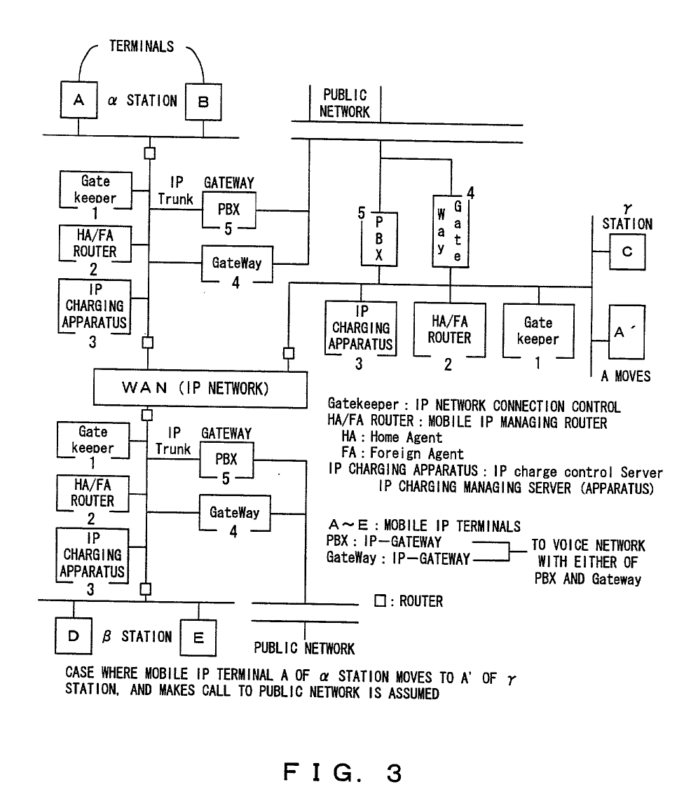

FIG. 3 shows the system configuration of the preferred embodiment according to the present invention.

In this figure, an IP charging apparatus (γ station-3) indicates the IP charging apparatus shown in FIG. 2.

A mobile IP terminal A′ (γ station-A′) is a mobile IP terminal A (α station-A) whose home station is the α station. The mobile IP terminal A′ (γ station-A′) and the mobile IP terminal A (α station-A) are the same mobile IP terminal, which moves from the home station (α station) to the different station (γ station).

When the mobile IP terminal A′ (γ station-A′) makes a call to a public network, this call is recorded to a gatekeeper (γ station-1) which is an exchange of the calling station.

The call record of the mobile IP terminal, which is stored in the gatekeeper (γ station-1), is received by a charging information obtaining unit of the IP charging apparatus (γ station-3) that dedicatedly calculates a charge (1) of FIG. 2. The charging information obtaining unit of the IP charging apparatus (γ station-3) issues a charge calculation request to a charge calculating unit of the IP charging apparatus (γ station-3) (2) of FIG. 2. The charge calculating unit of the IP charging apparatus (γ station-3) calculates a call charge based on the call record obtained by the charging information obtaining unit of the IP charging apparatus (γ station-3), and issues a charging information storage request to a charging information storing/managing unit of the IP charging apparatus (γ station-3) (3) of FIG. 2.

The charging information storing/managing unit of the IP charging apparatus (γ station-3) stores the charging information calculated by the charge calculating unit of the IP charging apparatus (γ station-3) in the charging information database (for local station transmission) D1, which is an external file (4) of FIG. 2. Data within the local station FA/HA router management table D4 within the IP charging apparatus (γ station-3) and an intra-network IP charging apparatus management table D5 within the IP charging apparatus (γ station-3) are assumed to be preset by an operation condition setting unit of the IP charging apparatus (γ station-3).

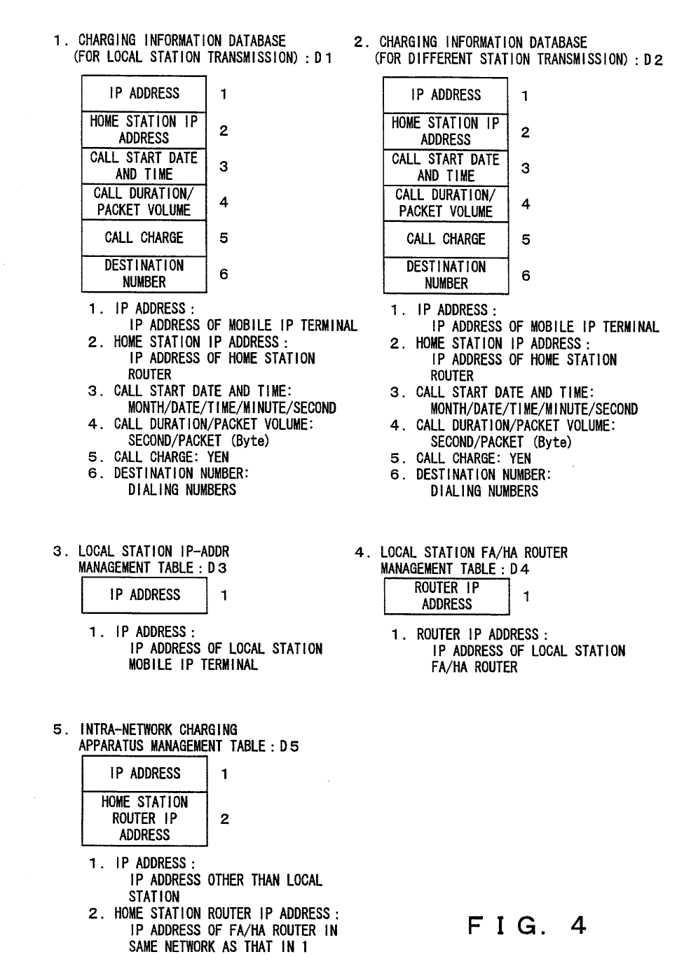

The MobileIP-Server searching unit of the IP charging apparatus (γ station-3) references an IP address (1-1 of FIG. 4 to be described later) within the charging information stored in the charging information database (for local station transmission) D1 (5) of FIG. 2, also references an IP address (4-1 of FIG. 4 to be described later) of the local station FA/HA router (γ station-2), which is registered to the local station FA/HA router management table D4 (6) of FIG. 2), inquires of the local station FA/HA router (γ station-2) about which station is the home station (7) of FIG. 2, and writes the router IP address of the home station to a home station IP address (1-2 of FIG. 4 to be described later) within the charging information stored in the charging information database (for local station transmission) D1.

If the home station written to the IP address (1-1 of FIG. 4 to be described later) is the local station (γ station), charging information is not distributed.

If the IP address (1-1 of FIG. 4 to be described later) is not the local station (γ station) (the IP address is assumed to be the α station), a request to determine the transmission destination (the IP charging apparatus of the different station (α station-3)) of the charging information is issued to the different station transmission determining unit of the IP charging apparatus (γ station-3) (8) of FIG. 2.

FIG. 4 shows the data structures used in the preferred embodiment.

1 of FIG. 4 shows the data structure of the charging information database (for local station transmission) D1. To 1-1, an IP address, which is an IP address of a mobile IP terminal, is registered. To 1-2, an IP address of a home station is registered. To 1-3, a call start date and time is registered in months, days, times, minutes, and seconds. 1-4 is a call duration/packet volume, which is registered in seconds/packets (bytes). 1-5 is a call charge, for example, on a yen basis. 1-6 is a destination number, and dialing numbers are registered.

2 of FIG. 4 shows the data structure of the charging information database (for different station transmission) D2. 2-1 is an IP address similar to 1-1 of this figure. 2-2 is an IP address of a calling station, which is an IP address of a router of a calling station. 2-3 is a call start date and time. 2-4 is a call duration/packet volume. 2-5 is a call charge. 2-6 is a destination number.

3 of FIG. 4 shows the local station IP-ADDR management table D3. 3-1, which is registration contents, is an IP address of a mobile IP terminal within a local station.

4 of FIG. 4 shows the local station FA/HA router management table D4. 4-1, which is registration contents, is an IP address of an FA/HA router of a local station.

5 of FIG. 4 shows the intra-network IP charging apparatus management table D5. 5-1, which is registration contents, is an IP address of an IP charging apparatus other than a local station. 5-2 is an IP address of an FA/HA router within the same network as that of the IP charging apparatus stored in 5-1.

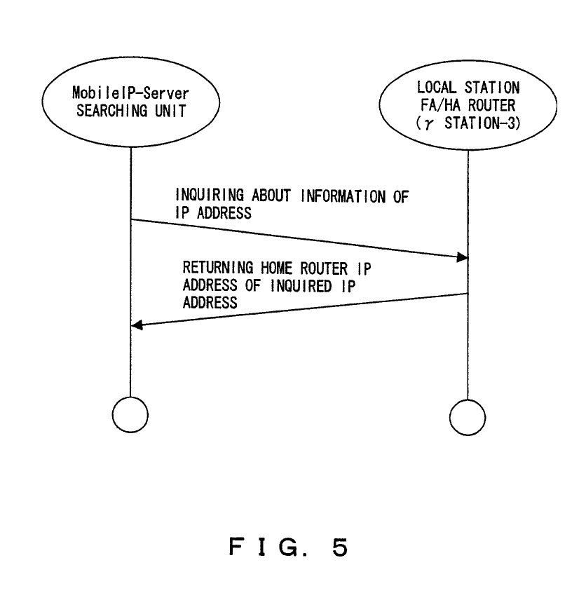

FIG. 5 shows the sequence of a communication between the MobileIP-Server searching unit and the FA/HA router in the preferred embodiment according to the present invention.

In response to an inquiry from the MobileIP-Server searching unit, the local station FA/HA router returns the IP address of a home station router to which an inquired IP address belongs.

The different station information transmission determining unit of the IP charging apparatus (γ station-3) determines the IP address of the home station router, which is searched by the MobileIP-Server searching unit of the IP charging apparatus (γ station-3), and the IP address of the IP charging apparatus, which matches the IP address of the home station router (5-2 of FIG. 4) within the intra-network IP charging apparatus management table D5 of the IP charging apparatus (γ station-3) (9) of FIG. 2, and issues a transmission request to the different station IP charging apparatus information transmitting unit of the IP charging apparatus (γ station-3) (10) of FIG. 2.

The different station IP charging apparatus information transmitting unit of the IP charging apparatus (γ station-3) transmits charging information to the IP address of the IP charging apparatus (α station-3), which is determined by the different station information transmission determining unit of the IP charging apparatus (γ station-3) (11) of FIG. 2.

The different station IP charging apparatus information receiving unit of the IP charging apparatus (α station-3) receives the charging information from the IP charging apparatus (γ station-3) of the γ station (12) of FIG. 2, and stores the charging information in the charging information database (for different station transmission) D2 of the IP charging apparatus (α station-3) (13) of FIG. 2.

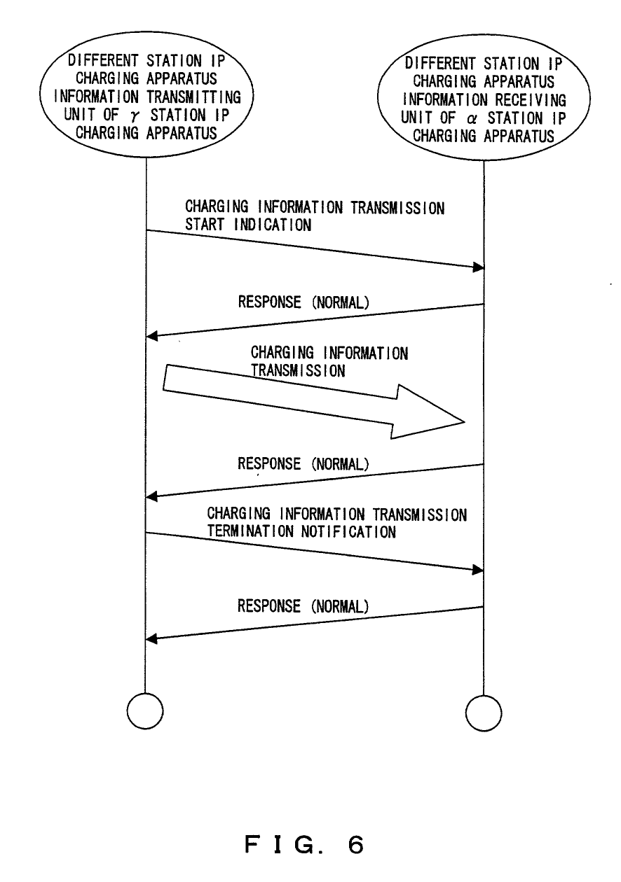

FIG. 6 shows the sequence of a communication (the case of a normal communication) between the different station IP charging apparatus information transmitting unit and the different station IP charging apparatus information receiving unit in the preferred embodiment according to the present invention.

Firstly, the different station IP charging apparatus information transmitting unit issues a charging information transmission start indication, and the different station IP charging apparatus information receiving unit returns a response (normal) Then, the different station IP charging apparatus information transmitting unit transmits charging information, and the different IP charging apparatus information receiving unit returns a response (normal). The different station IP charging apparatus information transmitting unit transmits a charging information transmission termination notification, and the different IP charging apparatus information receiving unit returns a response (normal). This sequence is a normal sequence.

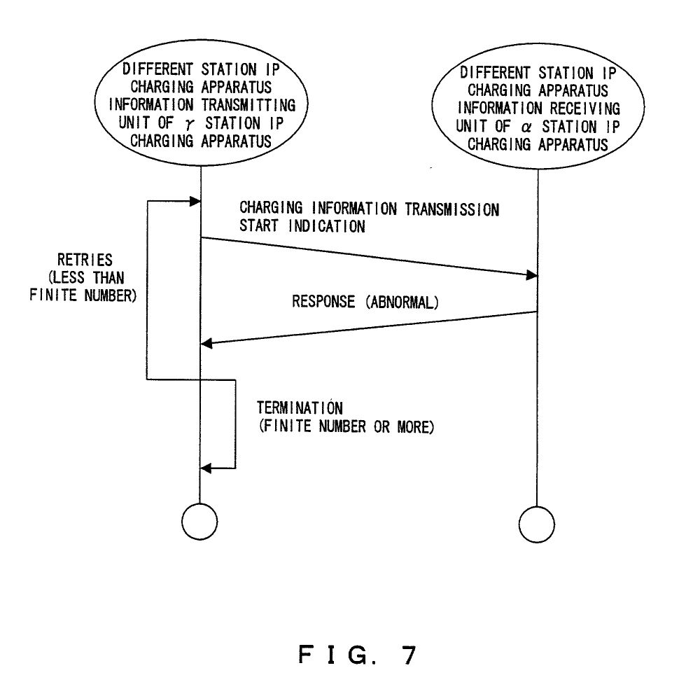

FIG. 7 shows the sequence of a communication (the case where a charging transmission start response is abnormal) between the different station IP charging apparatus information transmitting unit and the different station IP charging apparatus information receiving unit in the preferred embodiment according to the present invention.

If a response of the different station IP charging apparatus information receiving unit to a charging information transmission start indication from the different station IP charging apparatus information transmitting unit is abnormal, the charging information transmission start request is retried. If the number of retries is smaller than a predetermined number (finite value), the charging information transmission start indication is retried. If the number of retries is equal to or larger than the predetermined number (finite value), the communication terminates without retrying the charging information transmission start indication.

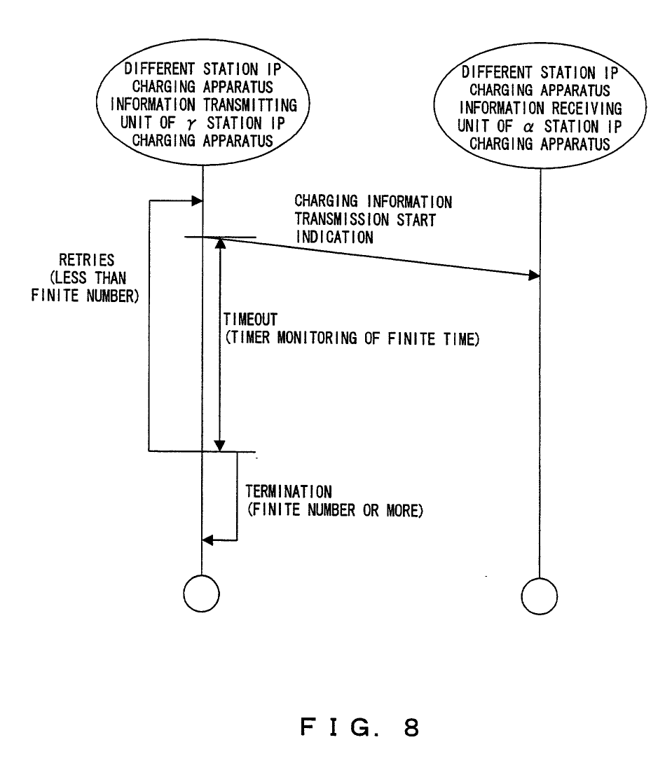

FIG. 8 shows the sequence of a communication (the case where a charging transmission start response is not returned) between the different station IP charging apparatus information transmitting unit and the different station IP charging apparatus information receiving unit in the preferred embodiment according to the present invention.

If a response of the different station IP charging apparatus information receiving unit to the charging information transmission start indication from the different station IP charging apparatus information transmitting unit is not returned, the charging information transmission start indication is retried after a predetermined timeout duration elapses. If the number of retries is smaller than a predetermined number (finite value), the charging information transmission start request is retried. If the number of retries is equal to or larger than the predetermined number (finite value), the communication terminates without retrying the charging information transmission start indication.

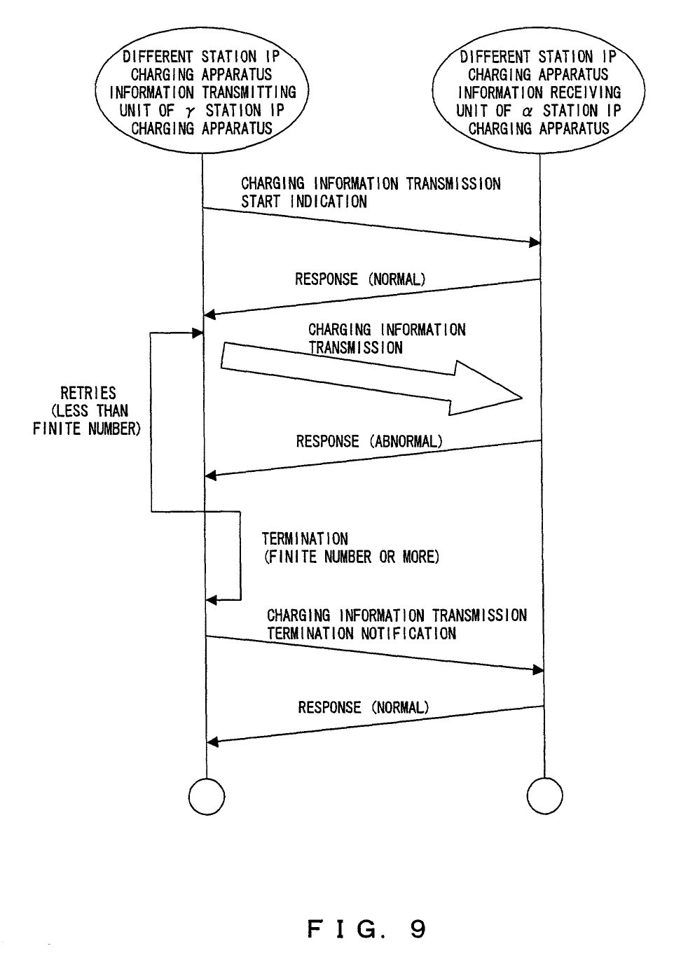

FIG. 9 shows the sequence of a communication (the case where a response to a charging information transmission is abnormal) between the different station IP charging apparatus information transmitting unit and the different station IP charging apparatus information receiving unit in the preferred embodiment according to the present invention.

If a response of the different station IP charging apparatus information receiving unit to the charging information transmission from the different station IP charging apparatus information transmitting unit is abnormal, the charging information transmission is retried. If the number of retries is smaller than a predetermined number (finite value), the charging information transmission is retried. If the number of retries is equal to or larger than the predetermined number (finite value), a charging information transmission termination notification is transmitted without retrying the charging information transmission.

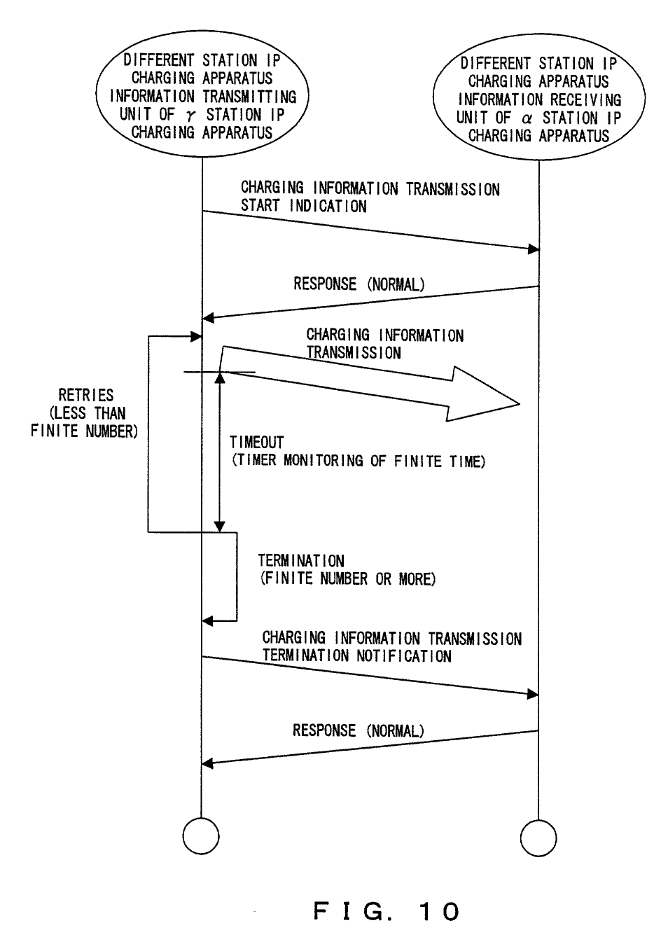

FIG. 10 shows the sequence of a communication (the case where a response to the charging information transmission is not returned) between the different station IP charging apparatus information transmitting unit and the different station IP charging apparatus information receiving unit in the preferred embodiment according to the present invention.

If a response of the different station IP charging apparatus information receiving unit to the charging information transmission from the different station IP charging apparatus information transmitting unit is not returned, the charging information transmission is retried after a predetermined timeout duration (finite time) elapses. If the number of retries is smaller than a predetermined number (finite value), the charging information transmission is retried. If the number of retries is equal to or larger than the predetermined number (finite value), a charging information transmission termination notification is transmitted without retrying the charging information transmission.

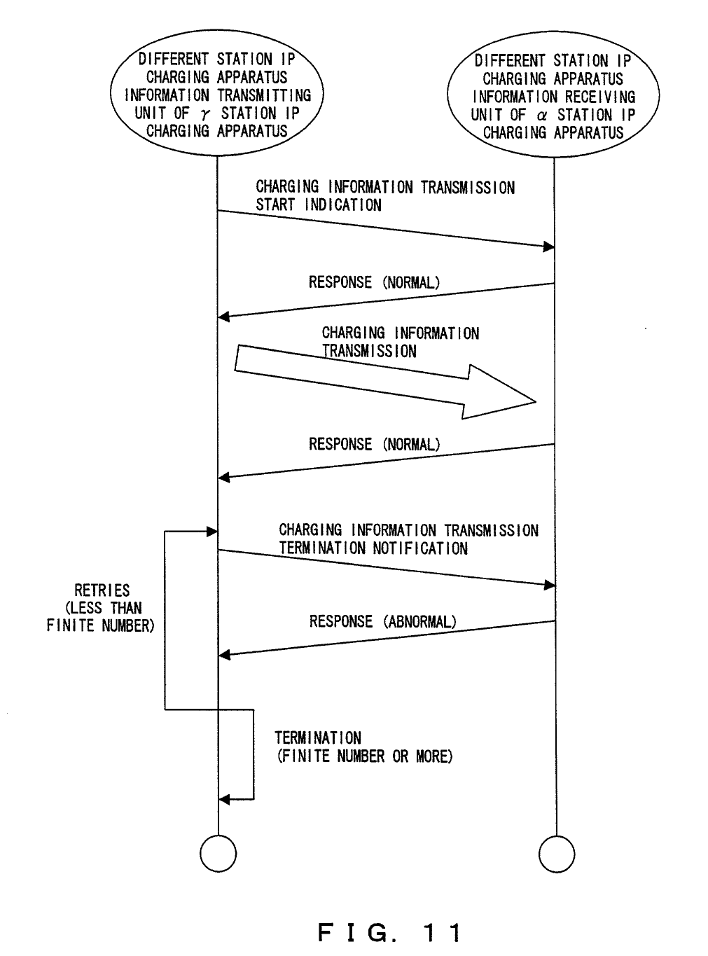

FIG. 11 shows the sequence of a communication (the case where a termination notification response is abnormal) between the different station IP charging apparatus information transmitting unit and the different IP charging apparatus information receiving unit in the preferred embodiment according to the present invention.

If a response of the different station IP charging apparatus information receiving unit to the charging information transmission termination notification from the different station IP charging apparatus information transmitting unit is abnormal, the charging information transmission termination notification is retried. If the number of retries is smaller than a predetermined number (finite value), the charging information transmission termination notification is retried. If the number of retries is equal to or larger than the predetermined number (the finite value), the communication terminates without retrying the charging information transmission termination notification.

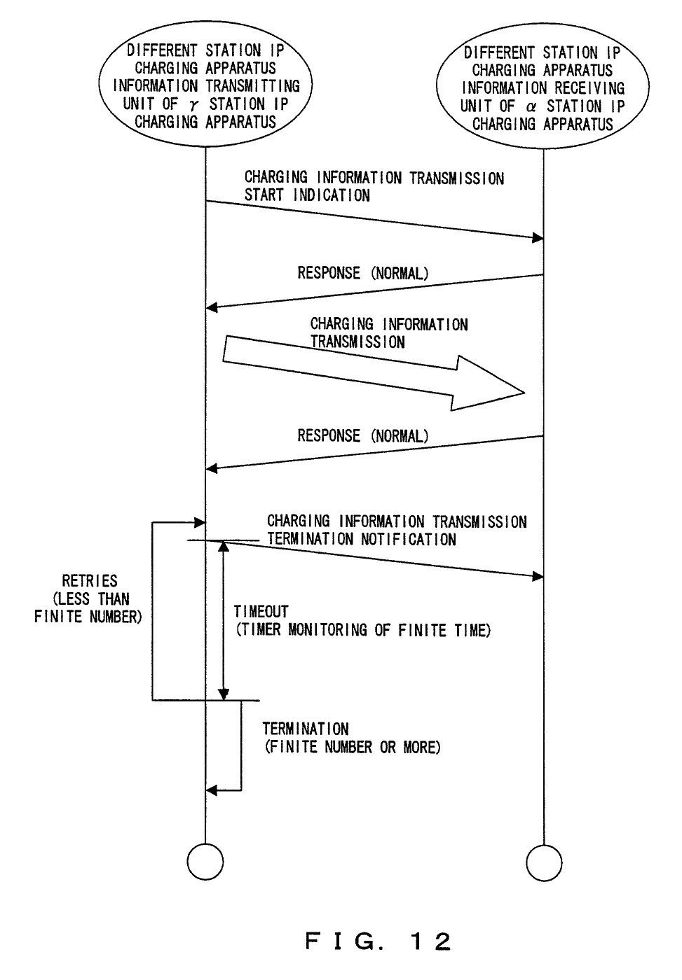

FIG. 12 shows the sequence of a communication (the case where a termination notification response is not returned) between the different station IP charging apparatus information transmitting unit and the different station IP charging apparatus information receiving unit in the preferred embodiment according to the present invention.

If a response of the different station IP charging apparatus information receiving unit to the charging information transmission termination notification from the different station IP charging apparatus information transmitting unit is not returned, the charging information transmission termination notification is retried after a predetermined timeout duration elapses (finite time). If the number of retries is smaller than a predetermined number (finite value), the charging information transmission termination notification is retried. If the number of retries is equal to or larger than the predetermined number (finite value), the communication terminates without retrying the charging information transmission termination notification.

In this way, the charging information of the mobile IP terminal A′ (γ station-A′) is stored in the charging information database (for different station transmission) D2 of the IP charging apparatus (α station-3) of the home station (α station).

Similarly, when a mobile IP terminal B (α station-B) whose home station is the α station makes a call to a public network, this call is recorded to a Gatekeeper (α station-1), which is an exchange of the calling station, and the charging information is stored in the charging information database (for local station transmission) D1 of the IP charging apparatus (α station-3) of the home station (α station).

The IP charging apparatus (α station-3) of the a station stores the charging information of both a call that a mobile IP terminal managed by the local station makes from the local station, and a call that the mobile IP terminal makes when moving to a different station.

In the α station, the outputting unit of the IP charging apparatus (α station-3) accepts an inquiry about information transmitted from a different station from a user of a mobile IP terminal (17) of FIG. 2, and obtains information of the charging information database (for different station transmission) D2, which is the information transmitted from a different station, for example, when making a payment (18) of FIG. 2. As a result, the information transmitted from the different station can be output to the user.

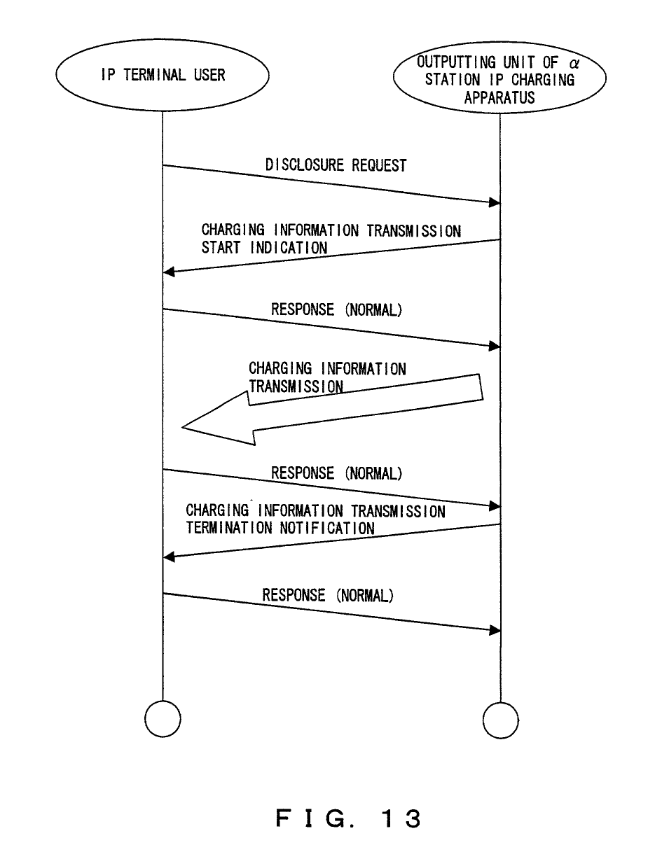

FIG. 13 shows the sequence of a communication (the case of a normal communication) between the outputting unit and a user of a mobile IP terminal in the preferred embodiment according to the present invention.

Firstly, the user of the mobile IP terminal issues a disclosure request. The outputting unit transmits a charging information transmission start indication, and the user of the mobile terminal returns a response (normal). The outputting unit then transmits charging information, and the user of the mobile IP terminal returns a response (normal). The outputting unit transmits a charging information transmission termination notification, and the user of the mobile IP terminal returns a response (normal). This sequence is a normal sequence.

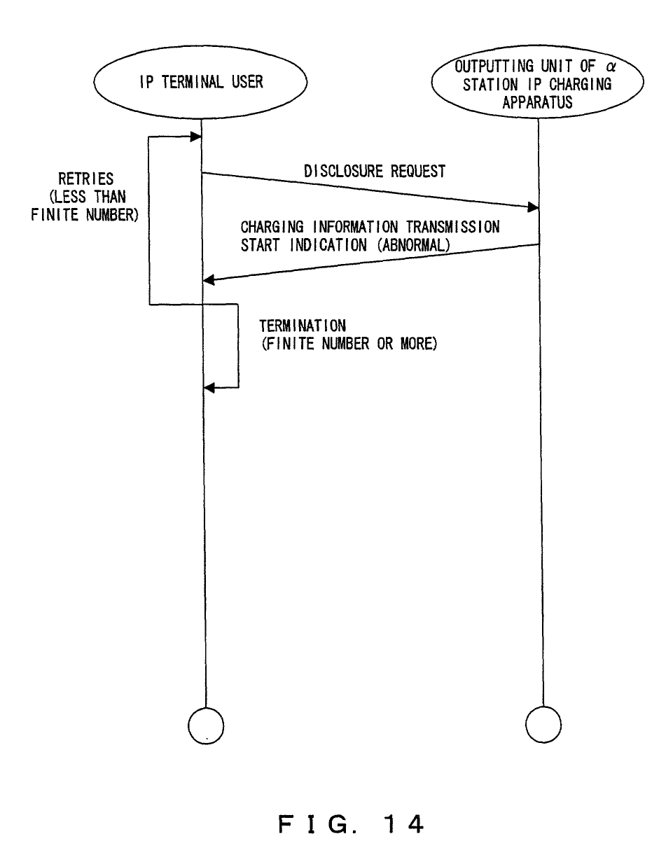

FIG. 14 shows the sequence of a communication (the case where an electronic message in response to a disclosure request is abnormal) between the outputting unit and a user of a mobile IP terminal.

If a response to a disclosure request from the user of the mobile IP terminal is abnormal, the disclosure request is retried. If the number of retries is smaller than a predetermined number (finite value), the disclosure request is retried. If the number of retries is equal to or larger than the predetermined number (finite value), the communication terminates without retrying the disclosure request.

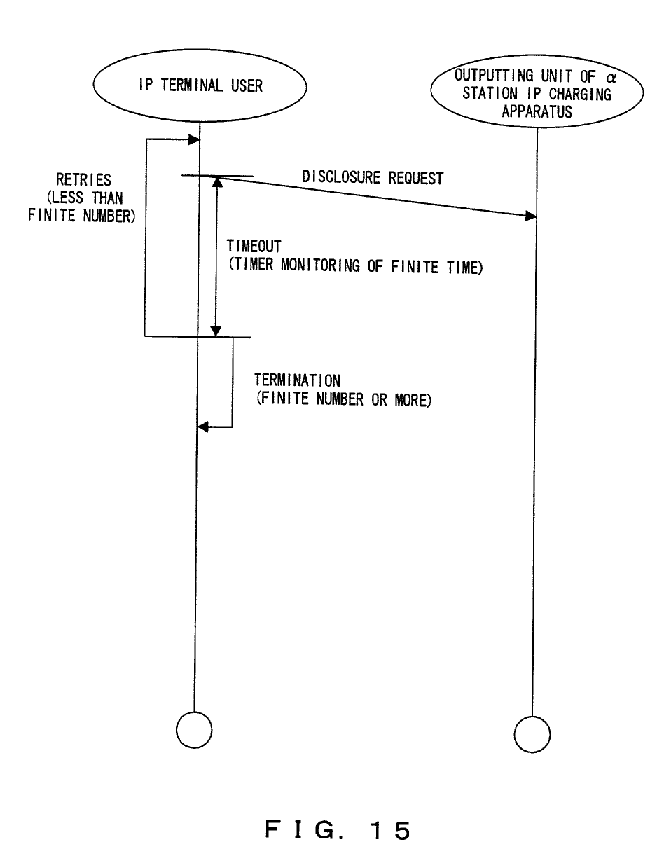

FIG. 15 shows the sequence of a communication (the case where a charging information transmission start indication (a response to a disclosure request) is not returned) between the outputting unit and a user of a mobile IP terminal in the preferred embodiment according to the present invention.

If a response to the disclosure request from the user of the mobile IP terminal is not returned, the disclosure request is retried after a predetermined timeout duration (finite time) elapses. If the number of retries is smaller than a predetermined number (finite value), the disclosure request is retried. If the number of retries is equal to or larger than the predetermined number (finite value), the communication terminates without retrying the disclosure request.

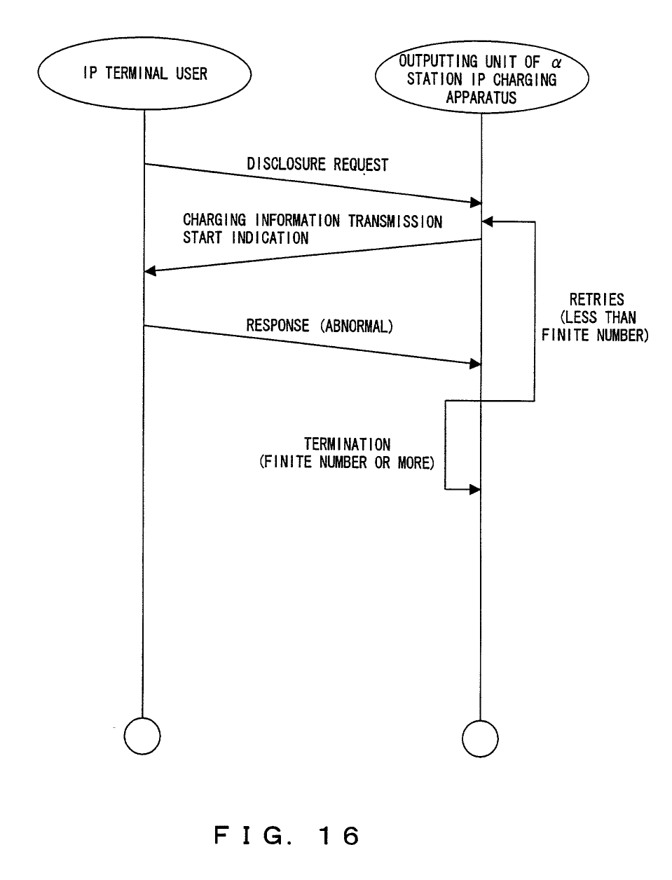

FIG. 16 shows the sequence of a communication (the case where a response to a charging information transmission start indication is abnormal) between the outputting unit and a user of a mobile IP terminal in the preferred embodiment according to the present invention.

If a response to the charging information transmission start indication from the outputting unit is abnormal, the charging information transmission start indication is retried. If the number of retries is smaller than a predetermined number (finite value), the charging information transmission start indication is retried. If the number of retries is equal to or larger than the predetermined number (finite value), the communication terminates without retrying the charging information transmission start indication.

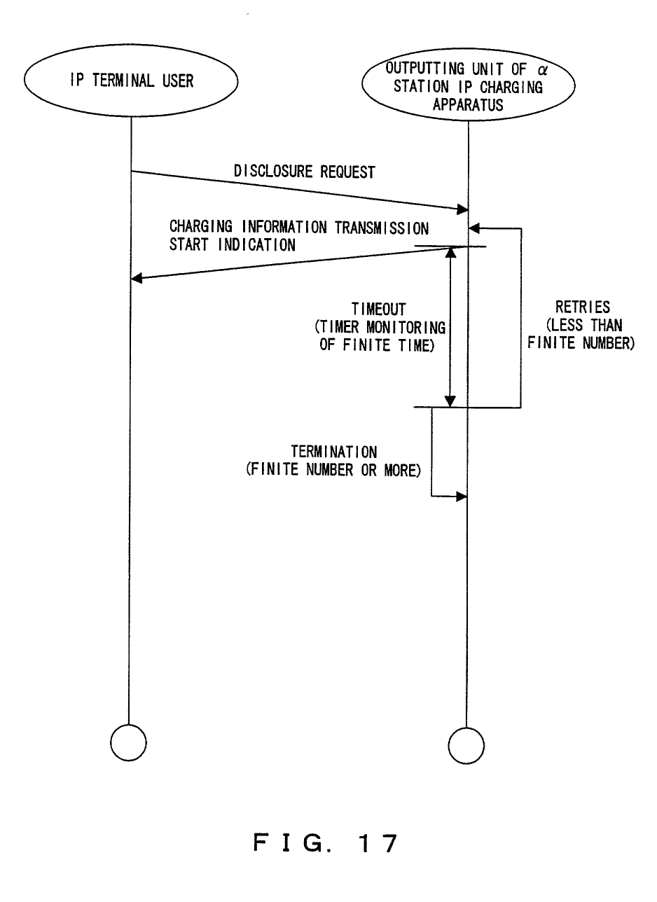

FIG. 17 shows the sequence of a communication (the case where a response to a charging information transmission start indication is not returned) between the outputting unit and a user of a mobile IP terminal in the preferred embodiment according to the present invention.

If a response to the charging information transmission start indication from the outputting unit is not returned, the charging information transmission start indication is retried after a predetermined timeout duration (finite time) elapses. If the number of retries is smaller than a predetermined number (finite value), the charging information transmission start indication is retried. If the number of retries is equal to or larger than the predetermined number (finite value), the communication terminates without retrying the charging information transmission start request.

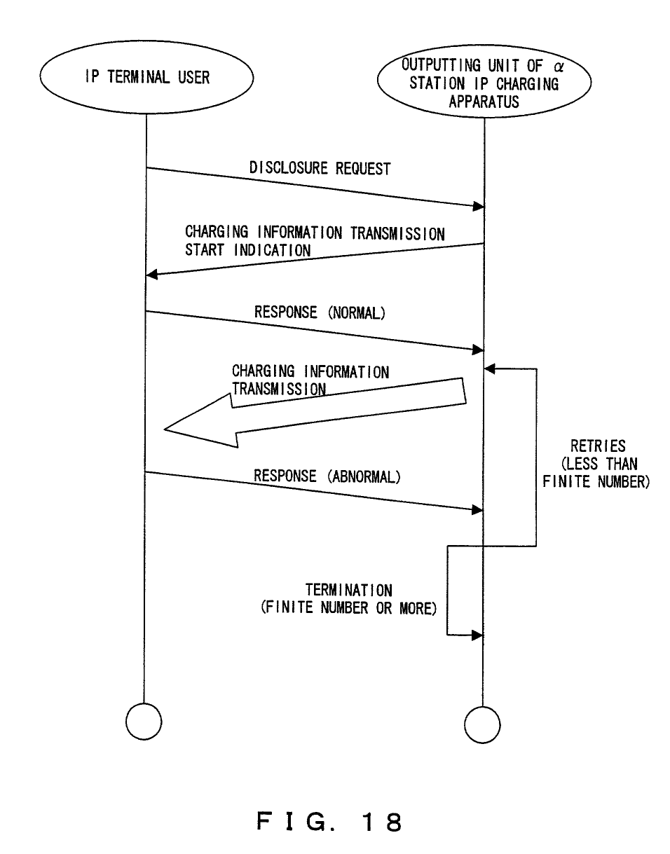

FIG. 18 shows the sequence of a communication (the case where a response to a charging information transmission is abnormal) between the outputting unit and a user of a mobile IP terminal in the preferred embodiment according to the present invention.

If a response to the charging information transmission from the outputting unit is abnormal, the charging information transmission is retried. If the number of retries is smaller than a predetermined number (finite value), the charging information transmission is retried. If the number of retries is equal to or larger than the predetermined number (finite value), the communication terminates without retrying the charging information transmission.

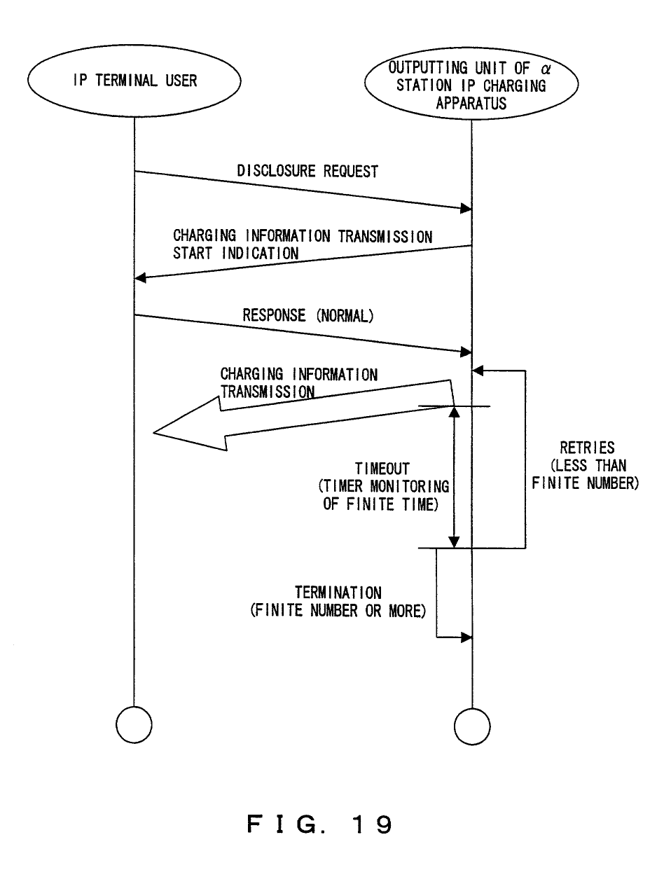

FIG. 19 shows the sequence of a communication (the case where a response to a charging information transmission is not returned) between the outputting unit and a user of a mobile IP terminal in the preferred embodiment according to the present invention.

If a response to the charging information transmission from the outputting unit is not returned, the charging information transmission is retried after a predetermined timeout duration (finite value) elapses. If the number of retries is smaller than a predetermined number (finite value), the charging information transmission is retried. If the number of retries is equal to or larger than the predetermined number (finite value), the communication terminates without retrying the charging information transmission.

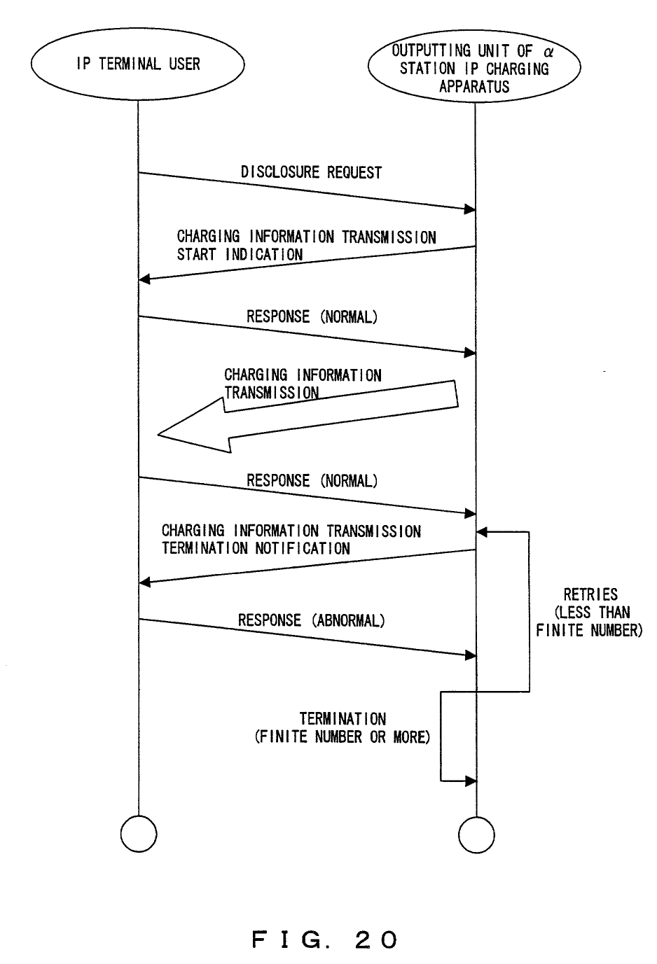

FIG. 20 shows the sequence of a communication (the case where a response to a charging information transmission termination notification is abnormal) between the outputting unit and a user of a mobile IP terminal in the preferred embodiment according to the present invention.

If a response to the charging information transmission termination notification from the outputting unit is abnormal, the charging information transmission termination notification is retried. If the number of retries is smaller than a predetermined number (finite value), the charging information transmission termination notification is retried. If the number of retries is equal to or larger than the predetermined number (finite value), the communication terminates without retrying the charging information transmission termination notification.

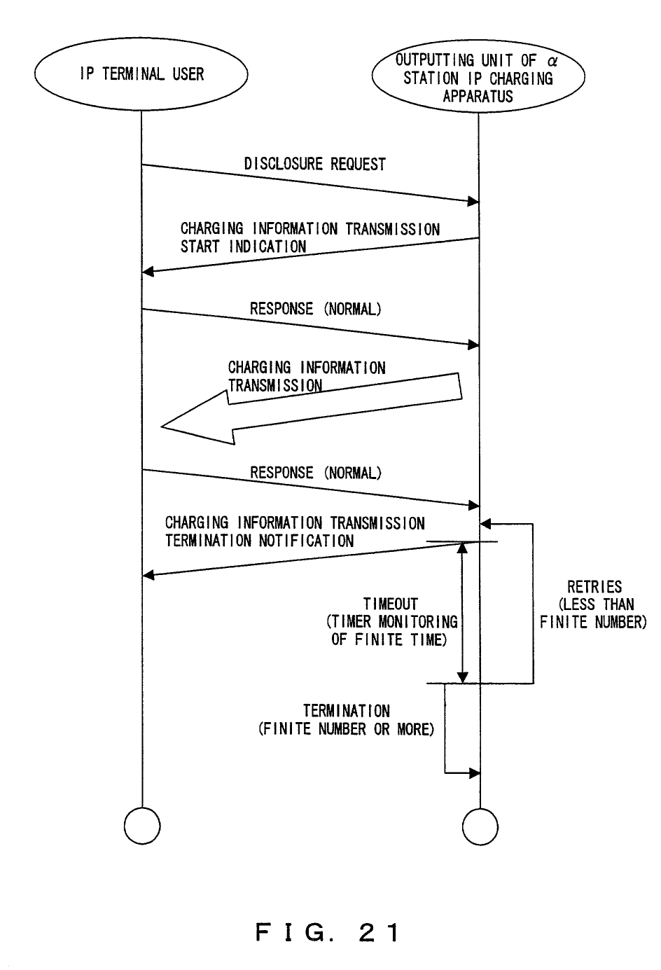

FIG. 21 shows the sequence of a communication (the case where a response to a charging information transmission termination notification is not returned) between the outputting unit and a user of a mobile IP terminal in the preferred embodiment according to the present invention.

If a response to the charging information transmission termination notification is not returned, the charging information transmission termination notification is retried after a predetermined timeout duration (finite value) elapses. If the number of retries is smaller than a predetermined number (finite value), the charging information transmission termination notification is retried. If the number of retries is equal to or larger than the predetermined number (finite value), the communication terminates without retrying the charging information transmission termination request.

In this preferred embodiment, from whichever IP private network point a mobile IP terminal makes a call to a public network, this call is stored as charging information within an IP charging apparatus of a calling station, and at the same time, the call is also automatically stored as charging information within an IP charging apparatus of the home station to which the mobile IP terminal belongs.

Furthermore, each time a MobileIP-Server searching unit of the IP charging apparatus (γ station-3) references an IP address within the charging information stored in the charging information database (for local station transmission) (1-1 of FIG. 4) (5) of FIG. 2, it inquires of the local station FA/HA router (γ station-2), which is registered to the local station FA/HA router management table D4, about which station is the home station of the IP address.

As another implementation method, when the MobileIP-Server searching unit of the IP charging apparatus (γ station-3) recognizes an IP address (1-1 of FIG. 4) within charging information stored in the charging information database (for local station transmission) D1 to be the IP address within the local station (1-1 of FIG. 4), the IP address may be automatically registered to the local station IP-ADDR management table D3 (14) of FIG. 2.

Namely, the IP address recognizing unit of the IP charging apparatus (γ station-3) makes a comparison between the IP address (3-1 of FIG. 4) within the local station IP-ADDR management table D3, which is automatically registered by the MobileIP-Server searching unit of the IP charging apparatus (γ station-3), and the IP address (1-1 of FIG. 4) within the charging information stored in the charging information database (for local station transmission) D1 of the IP charging apparatus (γ station-3) (5) of FIG. 2. If the IP addresses match, charging information may not be distributively transmitted. If they mismatch (if the IP address is that of the mobile terminal which moves to the γ station), a search request may be issued to the MobileIP-Server searching unit of the IP charging apparatus (γ station-3) (16) of FIG. 2, and an inquiry about which station is the home station of the IP address (4-1 of FIG. 4) of the local station FA/HA router (γ station-2), which is registered to the local station FA/HA router management table D4 (7) of FIG. 2, may be made.

Additionally, the MobileIP-Server searching unit of the IP charging apparatus ((γ station-3) periodically inquires of the local station FA/HA router (7) of FIG. 2). If a difference from the local station IP-ADDR management table D3 occurs, an IP address being the difference may be automatically deleted from the local station IP-ADDR management table D3 (14) of FIG. 2.

According to such a preferred embodiment, information of a mobile IP terminal whose home station is a local station is managed by the IP charging apparatus of the local station, so that the local station can be recognized as the home station without making an inquiry about the home station of the mobile IP terminal.

The above described preferred embodiment is explained below by using the flowcharts.

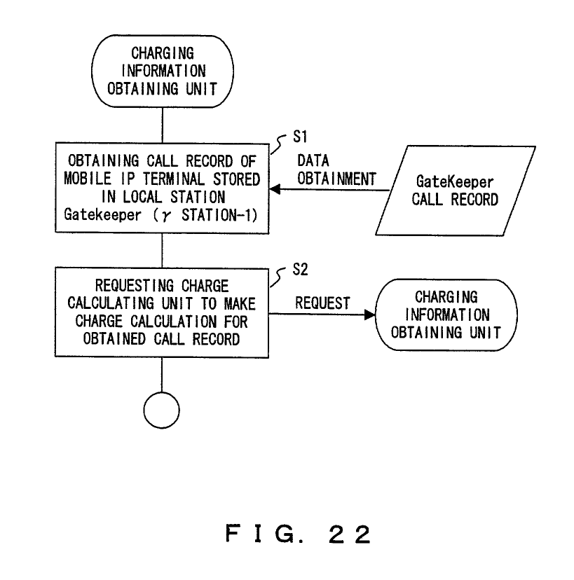

FIG. 22 shows the flow of the charging information obtaining unit in the preferred embodiment according to the present invention.

Firstly, in step S1, the charging information obtaining unit obtains a call record of a mobile IP terminal, which is stored in a Gatekeeper (γ station-1) of the local station, from the call record of the Gatekeeper. Then, in step S2, the charging information obtaining unit issues a charge calculation request to the charge calculating unit for the obtained call record.

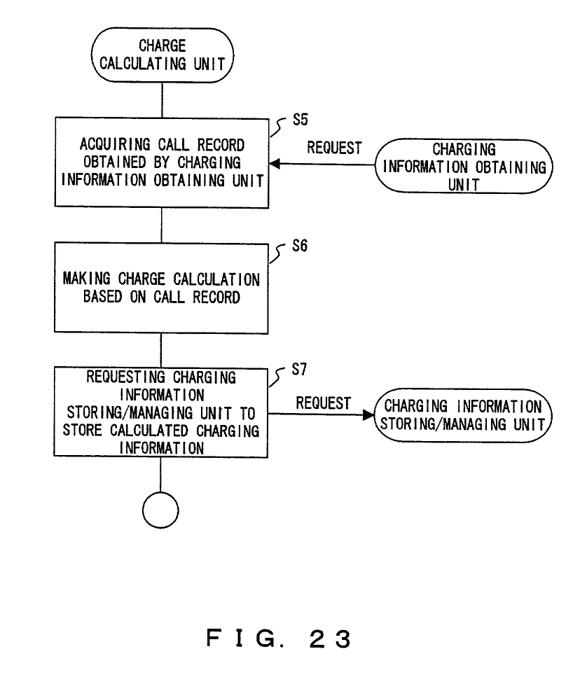

FIG. 23 shows the flow of the charge calculating unit in the preferred embodiment according to the present invention.

Firstly, in step S5, the charge calculating unit acquires the call record obtained by the charging information obtaining unit. Next, in step S6, the charge calculating unit makes a charge calculation based on the call record. Then, in step S7, the charge calculating unit issues a storage request for the calculated charging information to the charging information storing/managing unit.

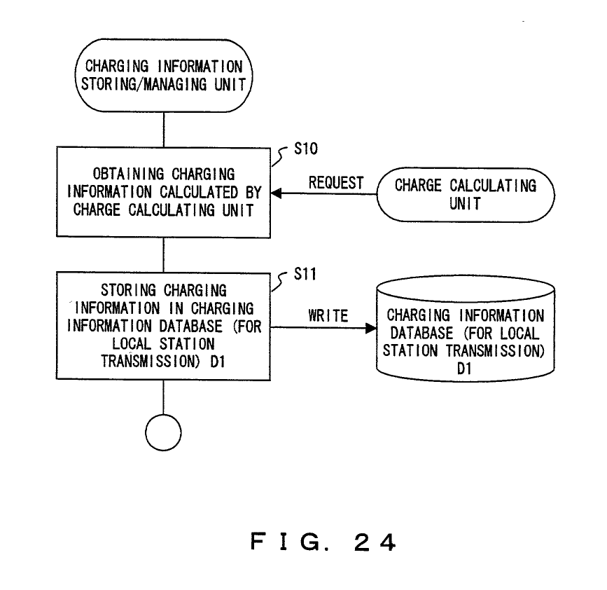

FIG. 24 shows the flow of the charging information storing/managing unit in the preferred embodiment according to the present invention.

The charging information storing/managing unit obtains the charging information calculated by the charge calculating unit in step S10. Then, in step S11, the charging information storing/managing unit writes the charging information to the charging information database (for local station transmission).

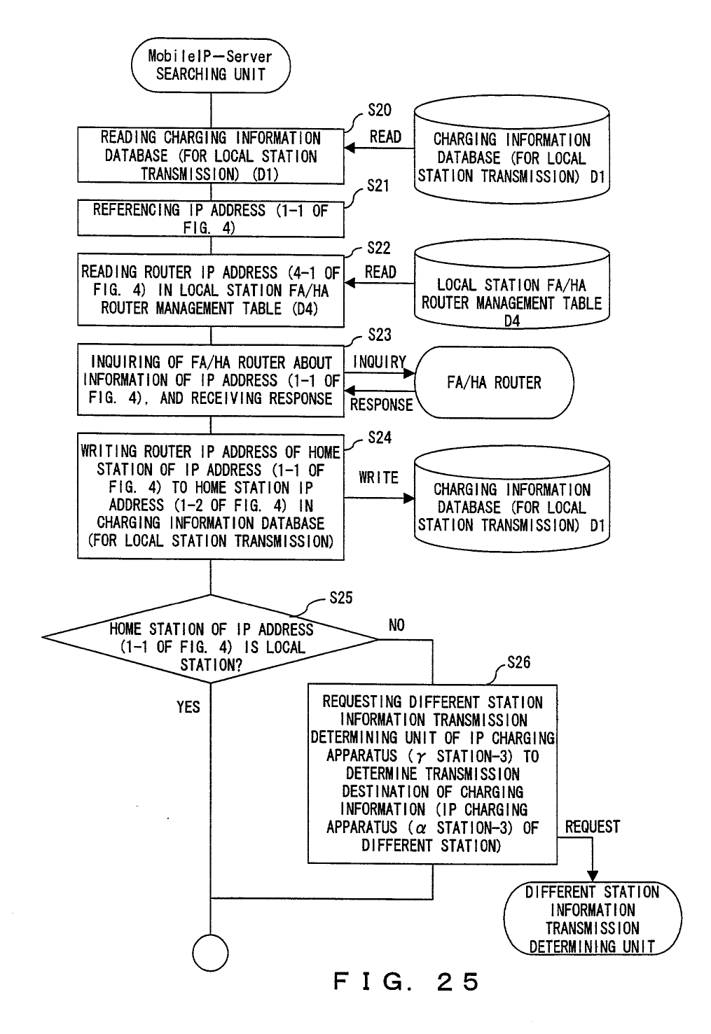

FIG. 25 shows the flow of the MobileIP-Server searching unit in the preferred embodiment according to the present invention.

The MobileIP-Server searching unit reads data to be processed from the charging information database (for local station transmission) D1 in step S20. In step S21, the MobileIP-Server searching unit references the IP address (1-1 of FIG. 4) of the data read from the charging information database (for local station transmission) D1. Next, in step S22, the MobileIP-Server searching unit reads the router IP address (4-1 of FIG. 4) in the local station FA/HA router management table D4. In step S23, the MobileIP-Server searching unit inquires of the FA/GA router about the information of the IP address (1-1 of FIG. 4), and receives a response. Namely, the home station IP address of the IP address is obtained from the FA/HA router. In step S24, the MobileIP-Server searching unit writes the router IP address of the home station of the IP address (1-1 of FIG. 4) to the home station IP address (1-2 of FIG. 4) in the charging information database (for local station transmission). In step S25, the MobileIP-Server searching unit determines whether or not the home station of the IP address (1-1 of FIG. 4) is the local station. If the determination made in step S25 is “YES”, a charging process is performed as conventional. If the determination made in step S25 is “NO”, the MobileIP-Server searching unit requests the different station information transmission determining unit of the IP charging apparatus (γ station-3) to determine the transmission destination (the IP charging apparatus (α station-3) of the different station) of the charging information.

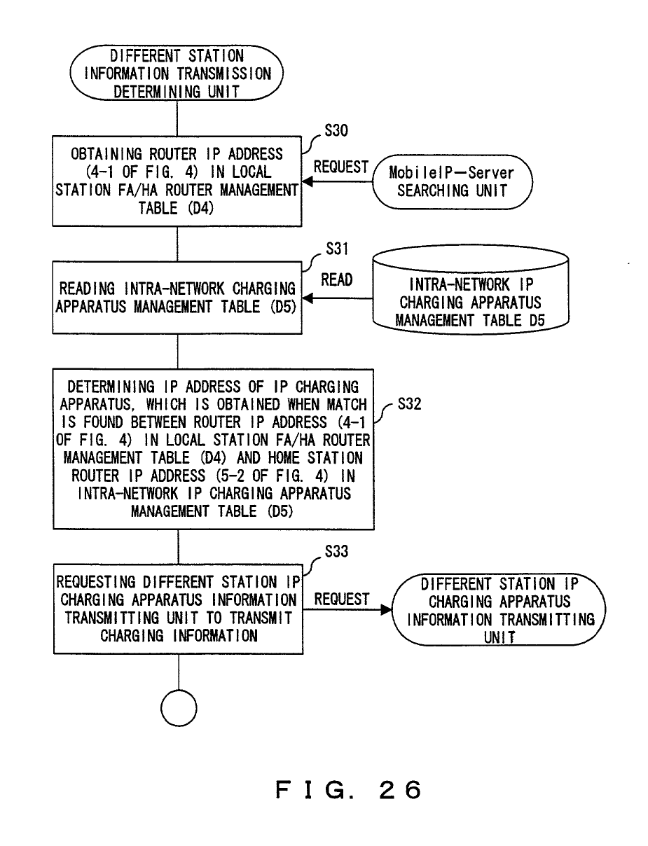

FIG. 26 shows the flow of the different station information transmission determining unit in the preferred embodiment according to the present invention.

The different station information transmission determining unit obtains the router IP address (4-1 of FIG. 4) in the local station FA/HA router management table D4 from the MobileIP-Server searching unit in step S30. In step S31, the different station information transmission determining unit reads data from the intra-network IP charging apparatus management table D5. In step S32, the different station information transmission determining unit determines the IP address of the IP charging apparatus, which is obtained when a match is found between the router IP address (4-1 of FIG. 4) in the local station FA/HA router management table D4 and the home station router IP address (5-2 of FIG. 4) in the intra-network IP charging apparatus management table D5. Then, in step S33, the different station information transmission determining unit requests the different station IP charging apparatus transmitting unit to transmit charging information.

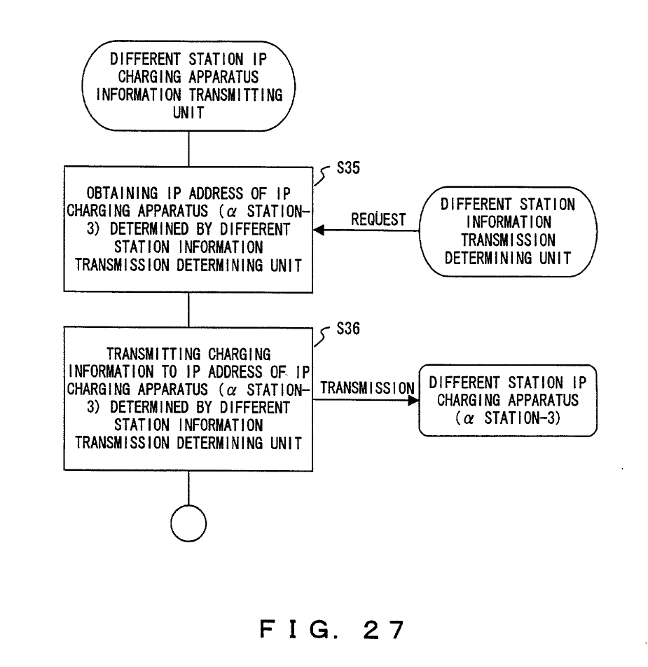

FIG. 27 shows the flow of the different station IP charging apparatus information transmitting unit in the preferred embodiment according to the present invention.

In step S35, the different station IP charging apparatus information transmitting unit obtains the IP address of the IP charging apparatus (α station-3) determined by the different station information transmission determining unit. Then, in step S36, the different station IP charging apparatus information transmitting unit transmits charging information to the IP address of the IP charging apparatus (α station-3) determined by the different station information transmission determining unit.

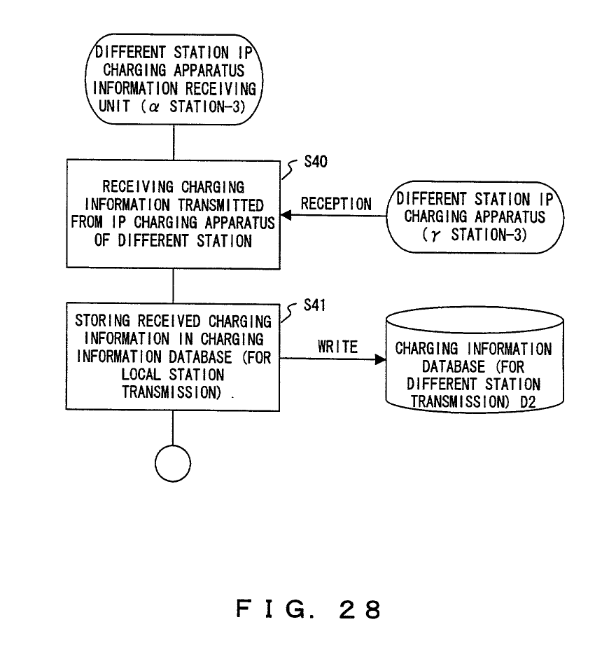

FIG. 28 shows the flow of the different station IP charging apparatus information receiving unit in the preferred embodiment according to the present invention.

The different station IP charging apparatus information receiving unit (α station-3) receives charging information transmitted from the IP charging apparatus (γ station-3) of the different station in step S40, and stores the received charging information in the charging information database (for different station transmission) D2 (of the α station) in step S41.

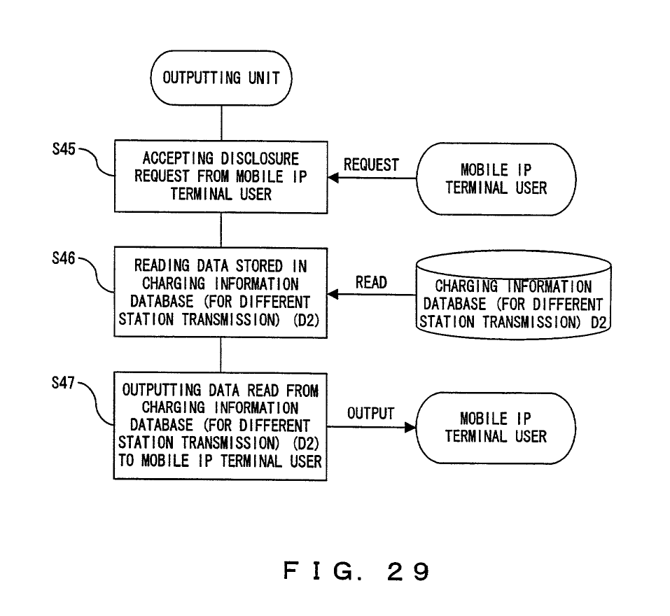

FIG. 29 shows the flow of the outputting unit in the preferred embodiment according to the present invention.

Firstly, the outputting unit accepts a disclosure request of charging information from a user of a mobile IP terminal in step S45. Then, the outputting unit reads the data stored in the charging information database (for different station transmission) D2 in step S46, and outputs the data read from the charging information database (for different station transmission) D2 to the user of the mobile IP terminal in step S47.

Here, the flow is shown for only the data stored in the database D2 for different station transmission among the charging information databases. However, since the database for local station transmission among the charging information databases is a conventional technique, its flow is omitted.

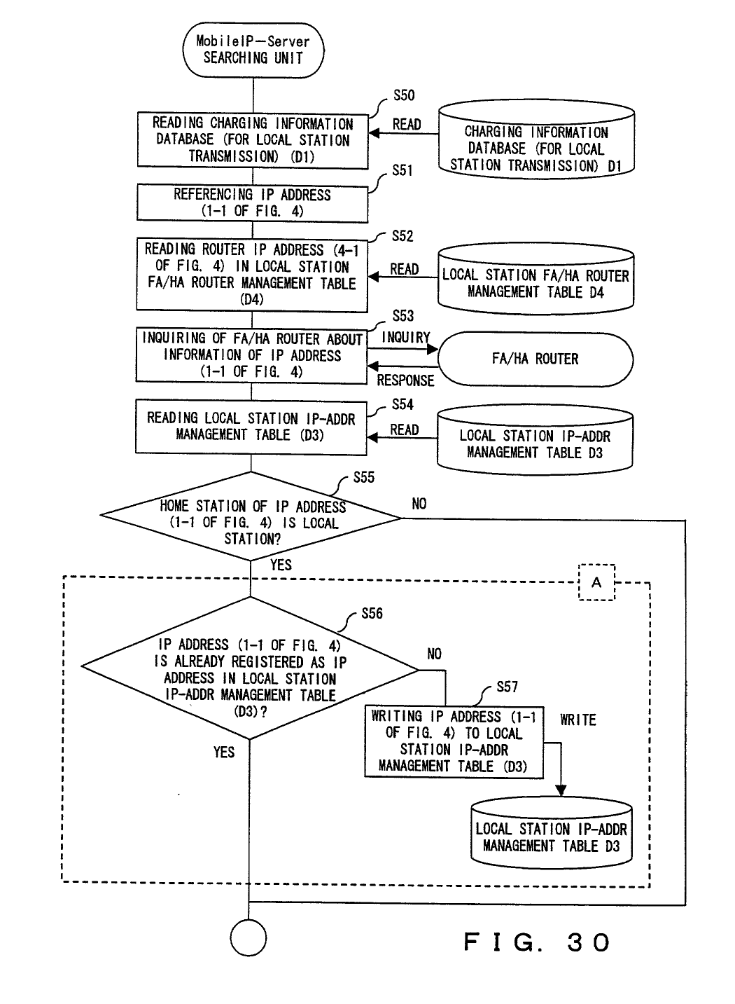

FIG. 30 shows the flow of the MobileIP-Server searching unit in the preferred embodiment according to the present invention (No. 1).

The flow shown in this figure represents the process performed when a result of determining whether or not the IP address searched by the MobileIP-Server searching unit is a local station is stored in the local station IP-ADDR management table.

Firstly, the MobileIP-Server searching unit reads data stored in the charging information database (for local station transmission) D1 in step S50, and references the IP address (1-1 of FIG. 4) in step S51. In step S52, the MobileIP-Server searching unit reads the router IP address (4-1 of FIG. 4) in the local station FA/HA router management table D4. Then, the MobileIP-Server searching unit inquires of the FA/HA router having the router IP address read in step S52 about the information of the IP address (1-1 of FIG. 4), and obtains a response in step S53. Then, the MobileIP-Server searching unit reads the local station IP-ADDR management table D3 in step S54.

In step S55, the MobileIP-Server searching unit determines whether or not the home station of the IP address (1-1 of FIG. 4) is the local station based on the response obtained from the FA/HA router in step S53. If the determination made in step S55 is “NO”, the Mobile IP-Server searching unit terminates the process. This is because there is no need to write the IP address to the local station IP-ADDR management table.

If the determination made in step S55 is “YES”, the MobileIP-Server searching unit determines whether or not the IP address (1-1 of FIG. 4) is already registered as the IP address in the local station IP-ADDR management table D3 based on the contents read in step S54 in step S56. If the determination made in step S56 is “YES”, the MobileIP-Server searching unit terminates the process. This is because there is no need to newly register the IP address to the local station IP-ADDR management table. If the result of the determination made in step S56 is “NO”, the MobileIP-Server searching unit writes the IP address (1-1 of FIG. 4) to the local station IP-ADDR management table D3 in step S57, and terminates the process.

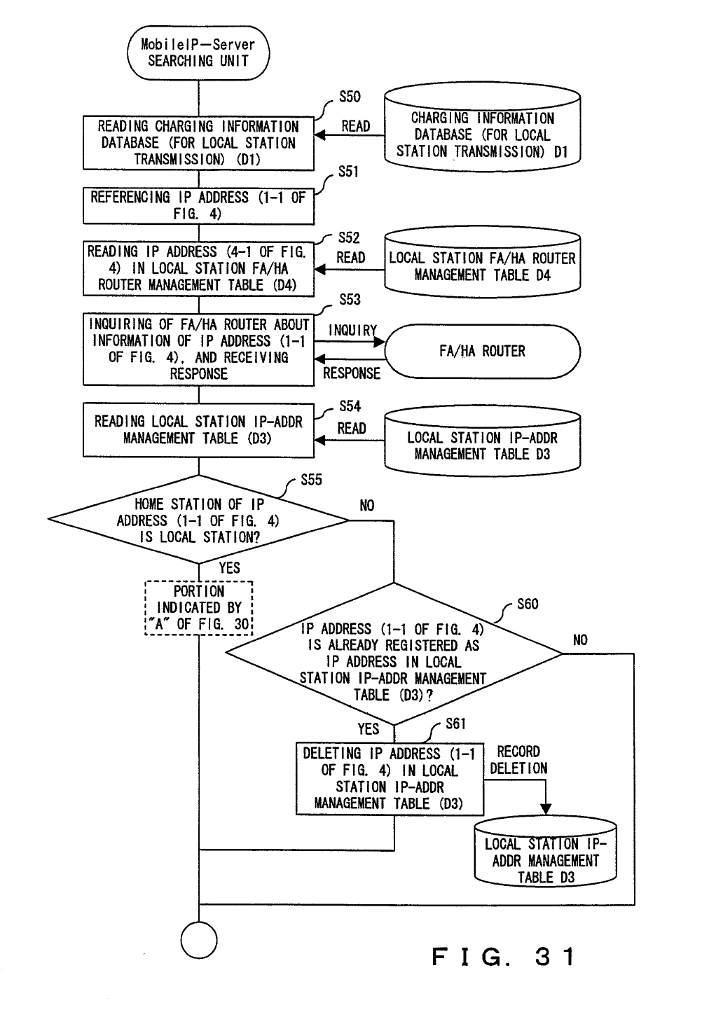

FIG. 31 shows the flow of the MobileIP-Server searching unit in the preferred embodiment according to the present invention (No. 2).

This figure shows the flow in the case where the MobileIP-Server searching unit registers/deletes the IP address of a mobile IP terminal to/from the local station IP-ADDR management table.

In this figure, the same steps as those shown in FIG. 30 are denoted with the same step numbers, and their explanations are omitted here.

In step S55, the MobileIP-Server searching unit determines whether or not the home station of the IP address (1-1 of FIG. 4) is the local station. If the determination made in step S55 is “YES”, the MobileIP-Server searching unit performs the process in the portion indicated by “A” of FIG. 30, and registers the IP address (1-1 of FIG. 4) to the local station IP-ADDR management table.

If the determination made in step S55 is “NO”, the MobileIP-Server searching unit determines whether or not the IP address (1-1 of FIG. 4) is already registered as the IP address in the local station IP-ADDR management table D3 in step S60. This determination is made according to the contents of the response obtained in step S53. If the determination made in step S60 is “NO”, the IP address in question is not stored in the local station IP-ADDR management table. Accordingly, there is no need to delete the IP address, and the MobileIP-Server searching unit terminates the process. If the determination made in step S60 is “YES”, the MobileIP-Server searching unit deletes the IP address (1-1 of FIG. 4) in the local station IP-ADDR management table D3 in step S61, and terminates the process.

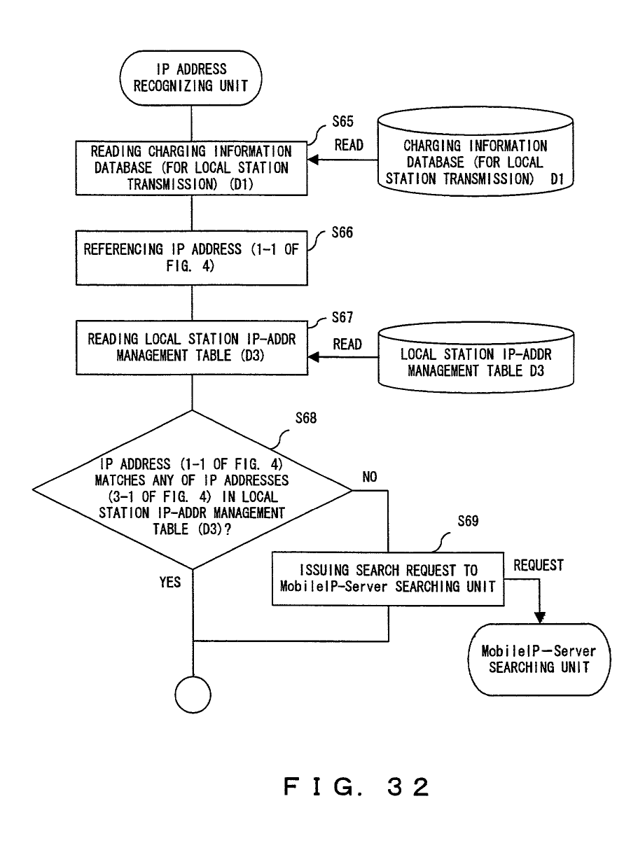

FIG. 32 shows the flow of the IP address recognizing unit in the preferred embodiment according to the present invention.

The IP address recognizing unit reads the data of the charging information database (for local station transmission) D1 instep S65. In step S66, the IP address recognizing unit references the IP address (1-1 of FIG. 4) of the read data in step S66, and further reads the data of the local station IP-ADDR management table D3 in step S67. Then, in step S68, the IP address recognizing unit determines whether or not the IP address (1-1 of FIG. 4) matches any of IP addresses (3-1 of FIG. 4) in the local station IP-ADDR management table D3.

If the determination made in step S68 is “YES”, the IP address recognizing unit terminates the process. This is because the IP address of the data read in step S65 is already registered. If the determination made in step S68 is “NO”, the IP address recognizing unit issues a request to search for the IP address to the MobileIP-Server searching unit. The MobileIP-Server searching unit that receives the request performs a process based on the flow shown in FIG. 30 or FIG. 31.

According to the present invention, to whichever location a mobile terminal moves within a network such as an IP private network, etc., charging information incurred when the mobile terminal makes a connection (call) with VoIP, etc. from the moving location remains in the network where the mobile terminal makes the call, and is also distributed automatically to the home location to which the mobile terminal belongs.

As a result, charging information of a mobile terminal in an entire network or at each location, and charging information at each location can be automatically updated/managed. Further, it becomes unnecessary to perform a manual operation for making a charge incurred at a moving destination to a home location, whereby a call charge can be quickly distributed and made.

Furthermore, information of a mobile terminal is managed within a charging apparatus, which eliminates the troublesomeness of inquiring of a router about the information. As a result, a communications workload within a network can be reduced.

What is claimed is:

1. A charging information managing apparatus, which is arranged in each of a plurality of stations, managing charging information when a mobile terminal makes a call via a network including the plurality of stations, comprising:
a searching unit searching for a home station of the mobile terminal to be charged for the call; and
a charging information transmitting unit transmitting charging information of the mobile terminal to the home station.

2. The charging information managing apparatus according to claim 1, wherein
the network is a network using Mobile IP.

3. The charging information managing apparatus according to claim 2, wherein
the network is an IP private network implementing VoIP.

4. The charging information managing apparatus according to claim 1, further comprising
a router management table storing information about a router existing within a local station.

5. The charging information managing apparatus according to claim 1 or 4, wherein
said searching unit inquires of a router existing within a local station about which station is the home station of the mobile terminal based on an address of the mobile terminal.

6. The charging information managing apparatus according to claim 1, further comprising
a local station charging information database storing charging information of a mobile terminal subordinate to a local station, wherein
said charging information transmitting unit transmits charging information of a mobile terminal whose home station is a different station to the home station from within the local station charging information database.

7. The charging information managing apparatus according to claim 1, further comprising
a charging information database for different station transmission storing charging information of a mobile terminal whose home station is a location station, and which makes a communication subordinately to a different station, wherein
charging information of a mobile terminal whose home station is the local station, which is transmitted from a different station, is managed.

8. The charging information managing apparatus according to claim 1, further comprising
a storing unit storing identification information of the mobile terminal whose home station is the local station.

9. The charging information managing apparatus according to claim 8, further comprising
an identification information storing unit determining whether or not the home station of the mobile terminal is the local terminal, and storing the identification information of the mobile terminal in said storing unit, if the home station of the mobile terminal is the local station.

10. A charging information managing method for use in an apparatus, which is arranged in each of a plurality of stations, managing charging information when a mobile terminal makes a call via a network including the plurality of stations, comprising:
searching for a home station of the mobile terminal to be charged for the call; and
transmitting charging information of the mobile terminal to the home station.

11. The charging information managing method according to claim 10, wherein
the network is a network using Mobile IP.

12. The charging information managing method according to claim 11, wherein
the network is an IP private network implementing VoIP.

13. The charging information managing method according to claim 10, further comprising
storing information about a router existing within a local network.

14. The charging information managing method according to claim 10 or 13, wherein
the searching step inquires of a router existing within a local station about which station is the home station of the mobile terminal based on an address of the mobile terminal.

15. The charging information managing method according to claim 10, further comprising
(a) storing charging information of a mobile terminal subordinate to a local station, wherein
the charging information transmitting step transmits charging information of a mobile terminal whose home station is a different station to the home station from within charging information stored in the step (a).

16. The charging information managing method according to claim 10, further comprising
storing charging information of a mobile terminal, whose home station is a local station, and which makes a communication subordinately to a different station, wherein
charging information of the mobile terminal whose home station is the local station, which is transmitted from a different station, is managed.

17. The charging information managing method according to claim 10, further comprising
storing identification information of the mobile terminal whose home station is the local station.

18. The charging information managing method according to claim 17, further comprising
determining whether or not the home station of the mobile terminal is the local station, and storing the identification information of the mobile terminal along with the identification information stored in the storing step, if the home station of the mobile terminal is the local station.
